(19) United States
(12) Patent Application Publication
(10) Pub. No.: US 2022/0404839 A1
(43) Pub. Date: Dec. 22, 2022

(54) SYSTEMS, APPARATUS, AND METHODS FOR REMOTE MONITORING AND PILOTAGE

(71) Applicant: Vadim Tzukerman, Petah Tiqva (IL)

(72) Inventor: Vadim Tzukerman, Petah Tiqva (IL)

(21) Appl. No.: 17/807,723

(22) Filed: Jun. 19, 2022

Related U.S. Application Data
(60) Provisional application No. 63/213,230, filed on Jun. 22, 2021.

(51) Int. Cl. G05D 1/06; B64C 39/02; G05D 1/00

(52) U.S. Cl. CPC G05D 1/0684; B64C 39/024; G05D 1/0022; B64C 2201/127; B64C 2201/146; B64C 2201/128

(57) ABSTRACT

Systems, apparatus, and methods for remote monitoring and piloting of a ship. Examples include a method of delivering remote monitoring equipment to the ship and establishing a data and communication exchange for shore-based pilotage of the ship from a remote location. The equipment usable for remote monitoring and communication between the ship and pilot (at the remote location) is stored in a package and delivered to the ship by unmanned aircraft. The package is distributed and installed by ship's crew to specified locations. The remote pilot while located ashore has access to all the information that is needed to assist in safe navigation of the ship by exchanging data and/or streaming real time video from the ship to shore. Additionally, the system may extract navigational data from the ship and transmit it to shore in real-time.

### PRIORITY

This application claims the benefit of priority to U.S. Provisional Patent Application No. 63/213,230 entitled “Method for remote monitoring” filed Jun. 22, 2021, the contents of which are incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

This disclosure relates generally to the field of ship pilotage. More particularly, the present disclosure relates to systems, computer programs, devices, and methods for remote monitoring and pilotage.

### DESCRIPTION OF RELATED TECHNOLOGY

For over 300 years maritime pilots have been providing assistance to ships arriving and departing harbors as well as docking and maneuvering through narrow channels. Marine pilots (also known as “maritime pilots,” “harbor pilots,” “port pilots,” or “pilots”) are maritime navigation experts possessing local knowledge of the particular waterway such as depth, currents, and various hazards which are important for safe navigation in local waters. Marine pilots perform pilotage operations, which include activities related to the navigation of vessels in which the marine pilot acts as an advisor to the master/captain of the vessel and as an expert on the local waters and their navigation.

In many major seaports, particularly for large ships, the use of marine pilots is required by law. Marine pilots use pilotage techniques that rely on nearby visual reference points and local knowledge of tides, swells, currents, depths and shoals that might not be readily identifiable on nautical charts without firsthand experience in certain waters. Marine pilots may also have experience instructing other vessels such as tugboats that can help guide a ship into port. This knowledge and experience is not expected of masters or the crew of ships and the ship's crew therefore relies on the expertise of the marine pilots to successfully navigate into port.

As over 90 percent of the world's goods are transported by sea, ports are an important part of the global supply chain. The ability for ships to efficiently berth including mooring, loading/unloading cargo/passengers, unmooring, and navigating out of the port means that more ships may use the port in a given period of time. When accidents occur, the consequences may be grave including: the lives of the ships' crews, marine pilots, and dockworkers may be lost; the port may be shutdown which may impact global trade; the ships may be unusable; and the environment around the port may be affected.

The marine pilot normally boards the ship via a specialized pilot boat (or sometimes a tug or helicopter) in an area designated as a pilot boarding area (marked as “pilot station” on navigational charts) prior to the ship's entry into the waters where pilot assistance is required, and the pilot departs the vessel after the ship is alongside the berth. Pilot boats can be from 7 meters to over 25 meters in length, built to withstand heavy seas and bumping against a 100,000-ton tanker ships. Typically, pilot boats are painted a highly visible color such as orange, red or yellow as they need to approach and engage with larger vessels. Engagement typically occurs prior to the breakwater. Pilot boats are high-powered and hence both very quick and durable purpose-built boats.

For boarding the vessel, a pilot boat approaches the ship on one of its sides (normally lee side to have the boat sheltered under the ship's hull from winds) where the ship's crew has a pilot ladder ready for marine pilot boarding. Boarding arrangements include a pilot ladder and a combination ladder in case a ship's freeboard is more than 9 meters. The marine pilot climbs up to 9 meters or more to the deck of the ship (or combination ladder if over 9 meters). The boarding operation is normally performed while the ship is moving, proceeding at maneuvering speed.

Once the pilot boat gets alongside the ship's hull, positioning itself under the pilot ladder, the marine pilot climbs up the pilot ladder to reach the ship's deck. The opposite procedure is performed for departing ships where the marine pilot boards the ship from shore and leaves the ship by pilot boat when the ship no longer requires the marine pilot's assistance.

Climbing the pilot ladder is typically seen as the most dangerous part of a pilot's work (especially in rough seas) that causes on average five fatalities every year worldwide and numerous injuries. Additionally, there are accidents involving the pilot boat itself (e.g., collision with another ship and sinking) and accidents during rigging of the pilot ladder (e.g., man overboard or injury from moving mechanical parts), which cause a number of additional casualties annually. Even small injuries may cause a marine pilot to become unfit for duty due to their inability to go up the pilot ladder where the pilot must exhibit high levels of fitness at times.

A marine pilot is tasked with aiding the captain/master of the ship in navigating the ship. Legally, the master has full responsibility for the safe navigation of their vessel, even when a pilot is on board. While on board during the operation, the marine pilot remains under the master's authority, and outside of the ship's command chain. In most ports (outside of, e.g., the Panama Canal), marine pilots do not physically control the ship, nor do they directly use the ship's equipment. Instead, the marine pilot will take over navigational duties on the bridge of the ship (“taking the con”) and will give commands to ship's team on the bridge. Deck officers verify the wheelsman is executing the commands properly and control the engine (thrusters) of the ship. Marine pilots also share no responsibility for the failure of the ships navigational control or information systems. While the pilot is on-board the ship is said to being under “master command and pilot's advice.” The master remains fully responsible for the navigation of the ship while the marine pilot acts in the role of advisor with no direct contact with the ship's equipment. As used herein, “pilot” and “marine pilot” refers to a non-crew member of the ship who is tasked with aiding navigation of the ship. As used herein, “captain” and “master” refer to the highest authority crew member of the ship.

### BRIEF DESCRIPTION OF THE DRAWINGS

FIG. 1 illustrates an exemplary operating environment for a delivery of a remote monitoring system via an unmanned aircraft according to aspects of the present disclosure.

FIG. 2 illustrates an exemplary operating environment useful for describing data exchange and communication between the ship and the remote monitoring system control center according to aspects of the present disclosure.

FIG. 3 is a block diagram illustrating an exemplary layout of remote monitoring system equipment on the ship.

FIG. 4 is a logical block diagram illustrating the remote pilotage system in the remote monitoring control center according to aspects of the present disclosure.

FIG. 5 is a logical block diagram illustrating an exemplary unmanned aircraft with attached package and unmanned aircraft controller apparatus in accordance with aspects of the present disclosure.

FIG. 6 is a logical flow diagram of one generalized method for remote pilotage, in accordance with the various principles described herein.

FIG. 7 is a block diagram illustrating various navigational equipment useful for remote pilotage according to aspects of the present disclosure.

### DETAILED DESCRIPTION

In the following detailed description, reference is made to the accompanying drawings which form a part hereof wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

### Example Operation

There is a long felt need for shore-based pilotage, though, up until now there has been no viable alternative solutions presented. A marine pilot's assistance is still required by the industry for the foreseeable future for both logistical and legal reasons. However, systems and methods that can make a marine pilot's job safer and more efficient can mean considerable savings for a port by, e.g., requiring fewer marine pilots and/or not requiring as many marine pilots on-call in case of pilot injury. Fewer accidents and injuries may also improve the average time ship's need to navigate in and out of the port. Remote systems may also translate into the need for fewer pilot boats to carry marine pilots and for marine pilots that are injured or disabled to continue to work.

Aspects of the present disclosure relate to systems and methods of establishing remote monitoring on a ship to provide assistance that would otherwise require a marine pilot to physically board the ship. The present techniques describe a method for establishing and performing remote monitoring of ship's navigation and docking by delivering necessary for monitoring equipment via an unmanned aircraft/drone (or UAV/UAS) to the ship, remotely connecting to the delivered equipment, and exchanging information (such as data or video).

Aspects of the present disclosure provide a method of delivering equipment for remote monitoring to the ship and establishing a data and communication exchange connection required for shore-based (or other non-ship) pilotage of the ship (i.e., navigational assistance). While described in terms of shore-based operation (in e.g., a shore control station), artists of ordinary skill will recognize that the described remote pilotage systems and methods can be used from anywhere, e.g., from a different location on the ship (e.g., an internal cabin), a different vessel, in the air (e.g., a plane or helicopter, from the maritime pilot's own home, or across the globe. The equipment used for remote monitoring and communication between ship and pilot is stored in a package and delivered to the ship by drone (or UAV/UAS). The delivered package may be recovered by the ship's crew. Once recovered, the equipment may be unboxed from the package, distributed, and installed by ship's crew to specified locations according to instructions (provided together with the equipment or agreed in advance). As soon as equipment is set up by ship's crew, the information exchange between equipment and shore Command Center will be established by RF communication (e.g., mobile, LTE, satellite etc.).

Aspects of the present disclosure provide the pilot with all the information the maritime pilot would access or perceive onboard the ship to assist in safe navigation. The system extracts navigational data from the ship and transmits it to shore in real time. The pilot may be located in a Command Center located ashore (in a building, a vehicle or another vessel) and may have access to all the information as if the pilot was physically present on the bridge of the ship. The pilot may have real-time communication with the ship's command (e.g., the ship's Captain) and access to all the viable navigational data required to perform typical Pilot duties for the vessel.

Aspects of the present disclosure enable a ship station out at sea to receive equipment and establish RF communication through it with pilotage services located ashore or in any other distant base suitable for establishing a Command Center (e.g., a building, a ship or a specialized vehicle). For the above purpose, the present disclosure describes a method where communication and surveillance/monitoring equipment is delivered to the ship by the means of an unmanned vehicle (e.g., unmanned aerial device commonly called a drone). Aspects of the present disclosure describe examples where the unmanned aerial device lands on the ship to deliver the package with the equipment and the package is unloaded by the ship's crew, as well as where drone drops the package on the designated area on the ship and returns to its base. In the dropped package, equipment to establish adequate monitoring and communication between the ship's command and the pilot providing pilotage service are included to safely perform the pilotage task. The equipment may include one or several modules equipped with cameras for transmitting real-time video to cover all the viewing angles required by the pilot to perform pilotage safely. The required viewing angles may be based on the International Convention for the Safety of Life at Sea (SOLAS) regulations regarding a pilot's view of the sea surface from the conning position on the bridge of the ship. Additionally, modules may be included to transmit the information to the command center to the pilot's control/conning position via RF (e.g., mobile, LTE/5G, satellite etc.)

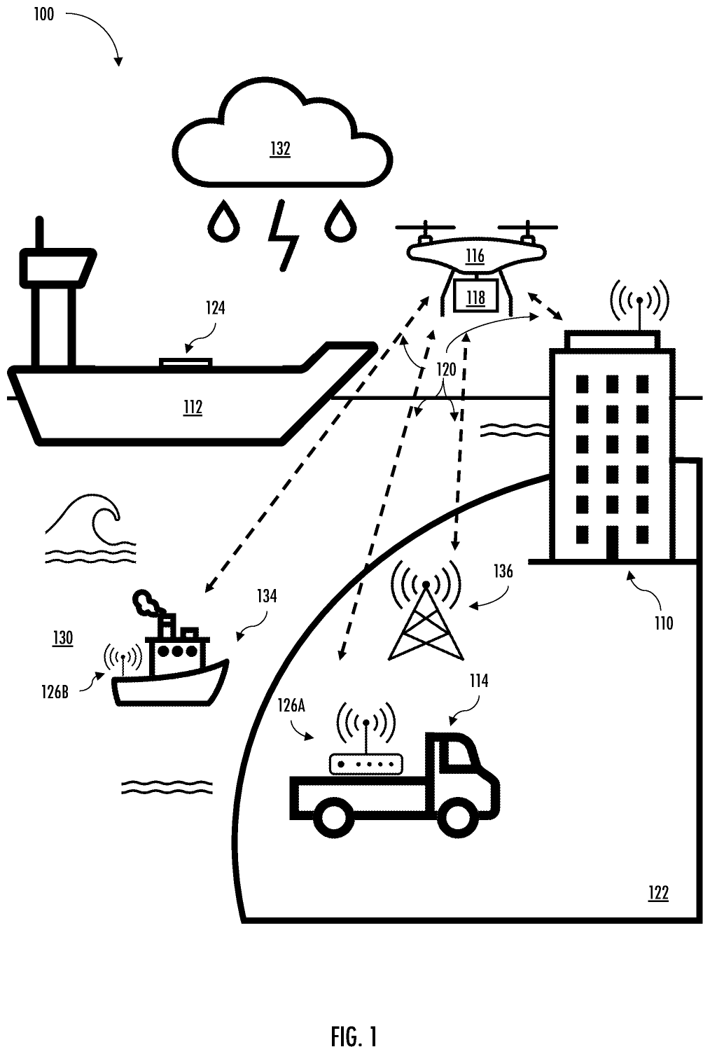

FIG. 1 illustrates an exemplary operating environment 100 for a delivery of a remote monitoring system via an unmanned aircraft 116 according to aspects of the present disclosure.

Referring to FIG. 1, a ship 112 at sea 130 is approaching a port to berth and unload cargo. The ship 112 requests pilotage services from the port. The ship 112 may make the request via a radio communication (e.g., via the VHF, MF, or HF bands) to a pilot or operator at a remote monitoring system control center 110 on shore 122. In an alternate embodiment, the ship 112 requests pilotage services via a connection to an application or interface accessible via a telecommunications network (e.g., the Internet). This information may be used to customize or select the surveillance equipment delivered to the ship 112 in the package 118.

In some examples, information about the ship 112 is transmitted to the remote monitoring system control center 110. Information may include data about the vessel such as the vessel type/subtype (e.g., tanker/petroleum product tanker), the year the ship 112 was built, owner information, the builder, identification (e.g., hull) number(s), and registration information. Capacity information of the vessel may be included, for example, the gross/net tonnage, displacement, and/or dry/liquid capacity. Dimension information of the vessel may be included, for example, the overall vessel length, the keel to manifold distance, the draught (distance between the waterline and keel), the air draught (the distance from the waterline to the highest point on the vessel). Propulsion information may include the engine model/designer, the number of engines, the maximum output, the propeller type and number of propellers, and propulsion type.

The unmanned aircraft 116 may select (e.g., pick up/connect with) different packages for different ships, e.g., larger ships, new ships with modern equipment and data interfaces, older ships without modern data interfaces (which may require video streaming of navigational panels). An operator may also pack a specific set of equipment for the needs of the particular ship/class of ship that requests remote pilotage and attach the customized package 118 to the unmanned aircraft 116.

The ship 112 awaits an unmanned aircraft 116 to deliver the remote monitoring system for remote pilotage. A drone operator (who, in some examples, is a marine pilot), launches and monitors/controls the unmanned aircraft 116 from a drone control center. The unmanned aircraft 116 may be controlled via a connection to a communication network via a communication link 120 to, e.g., base station 136 or mobile cells 126A and 126B on the specialized vehicle 114 and specialized ship 134 (which may act as the drone control center). In other embodiments, other Radio Access Technologies (RATs) and connection mechanisms, e.g., a direct data link (e.g., Wi-Fi), a satellite connection, or a combination thereof based, e.g., on the connection quality at flight time may be used by the port/network operators to provide a robust connection (or connections) to unmanned aircraft 116 as well as vessels at sea 130 (e.g., the ship 112).

As a brief aside, in a wireless network, multiple Radio Access Technologies (RATs) may be deployed (e.g., LTE, UMTS, Wi-Fi, etc.). Within each technology, a wireless network operator may deploy base stations, e.g., base station 136, (e.g., also referred to as “cells” in cellular communication technologies, and in some wireless communication technologies, such as Wi-Fi, referred to as “access points”) to provide wireless access to devices. Within each Radio Access Technology (RAT), the wireless network operator deploys macrocells as well as small cells (e.g., microcells, picocells, femtocells, etc.), operating on multiple frequencies. In addition, co-channel deployments may be used by wireless network operators, both within one RAT as well as across multiple RATs (e.g., Wi-Fi and LTE in the un-licensed spectrum).

As shown, the cellular network is comprised of different types of cells sharing the same frequency, which are shown as base station 136 as well as mobile cells 126A and 126B. For example, the base station 136 and the mobile cells 126A and 126B may act as a base station of a macrocell, microcell, picocell, and/or femtocell. Within each cell, there is a base station providing cellular service (e.g., voice, data, and/or other wireless network communication services) over the air to user equipment (UEs) such as unmanned aircraft 116, the surveillance and communication equipment in package 118, and other aspects of the drone control center. Each cell's footprint or coverage area can vary and may overlap with neighboring cells.

As illustrated, the drone control center may be a mobile drone control center operated out of a specialized vehicle 114. In some examples, the drone control center may be co-located with the remote monitoring system control center 11o in a building or a specialized vehicle 114 ashore 122. In other examples, the drone control center may be operated out of a specialized ship 134 at sea 130 (or at pier). Both drone control centers (specialized vehicle 114 and specialized ship 134) can reside near each other or being separated as per operational requirements.

Unmanned aircraft 116 (also known as a “drone,” a remotely piloted aircraft system (RPAS), an unmanned aerial vehicle (UAV), and an unmanned Aircraft System (UAS)) is a powered, aerial vehicle that does not carry a human operator, uses aerodynamic forces to provide vehicle lift, can fly autonomously or be piloted remotely. Unmanned aircraft 116 is configured to carry a payload of a package 118 to and from a ship 112. A port may have a fleet of different types of unmanned aircraft 116 for use in different weather conditions, on different ships, and to carry different packages.

The unmanned aircraft 116 carries the package 118 for delivery to the ship 112 requiring pilotage services. The unmanned aircraft 116 is configured to operate in a variety of weather conditions 132. These weather conditions 132 include precipitation (rain, snow, hail), windy, low visibility, and/or extreme temperatures (e.g., sub-freezing temperatures). The unmanned aircraft 116 may be operable in bad weather environments with protections including water proofing, a durable outer layer (e.g., a rubberized covering), heating elements (for, e.g., batteries). In some examples, the unmanned aircraft 116 may be configured to recover from a water landing (e.g., right itself, and re-takeoff).

The drone control center exchanges information with remote monitoring system control center 110. In some exemplary embodiments, drone control center is the same or is in the same facility as the remote monitoring system control center 110. The ship 112 requiring pilot assistance services is illustrated as having a designated area 124 for unmanned aircraft landing (or package offloading) ready for receiving the unmanned aircraft 116 and/or package 118.

In one exemplary embodiment, a drone pilot may fly the unmanned aircraft 116 from shore 122 (or sea 130, e.g., from specialized ship 134) carrying the package 118. In other embodiments, coordinates, directions, or ship 112 information are programed and the unmanned aircraft 116 may autonomously (or semi-autonomously) fly to the ship 112.

In some exemplary embodiments, once the package 118 is delivered to the ship 112, the unmanned aircraft 116 departs to deliver another package to a different ship. In other embodiments, the unmanned aircraft 116 remains with the ship 112 until the remote pilotage operation has completed and the surveillance and communication equipment in package 118 is re-packaged and collected by the unmanned aircraft 116 for delivery to another ship or back to the drone control center or storage facility for storage, refueling/recharging, and maintenance. In a further embodiment, the unmanned aircraft itself is used as part of the surveillance and communication equipment. For example, cameras on the unmanned aircraft 116 or the unmanned aircraft 116 itself may be mounted to the ship 112. In another example, a network/data connection from the unmanned aircraft 116 may service or act as a network hub for the surveillance and communication equipment.

When the unmanned aircraft 116 lands or touches down on the ship 112 at the designated area 124, the crew of the ship 112 may unload the package 118 and distribute the surveillance and communication equipment from the package 118 to various locations on the ship 112 (e.g., the bridge, sides, forward and aft sections). Package 118 may include set-up instructions within the package 118. Alternatively, instructions may be provided by other means (e.g., via radio transmission). Once setup, a data/communication connection is made between the equipment from package 118, the ship 112, and the marine pilot located at the remote monitoring system control center 110.

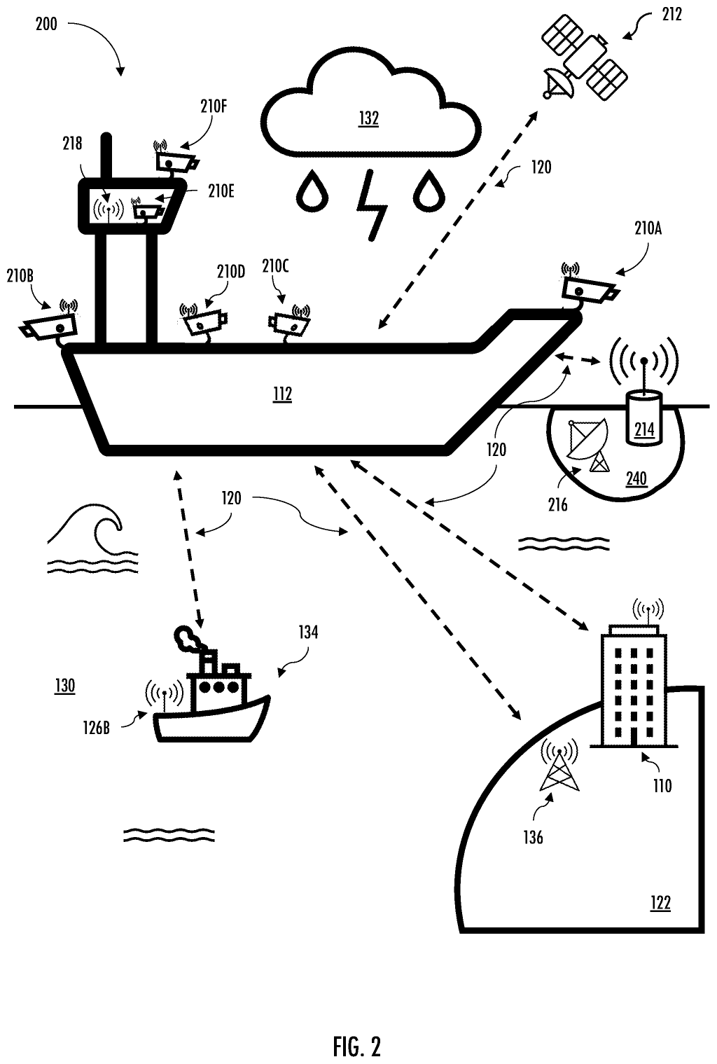

FIG. 2 illustrates an exemplary operating environment 200 useful for describing data exchange and communication between the ship 112 and the remote monitoring system control center 11o according to aspects of the present disclosure.

Referring to FIG. 2, after the unmanned aircraft 116 delivers the package 118, the ship 112 at sea 130 has the remote monitoring system (including, e.g., cameras 210A-F and navigational data module 218) on board the ship 112.

In some exemplary embodiments, crewmembers aboard the ship 112 set up the remote monitoring system (e.g., cameras 210A-F and navigational data module 218) as per instructions received either via radio communication with the remote monitoring system control center 11o or the drone control center, or instructions contained within the package 118. In other embodiments, the unmanned aircraft 116 may setup the remote monitoring system (e.g., cameras 210A-F and navigational data module 218) directly (by acting as one or more module, e.g., as a camera and/or by attaching one or more package 118 to various areas of the ship 112). This setup may be based on the size or other information or characteristic of the ship 112 (as described above).

The communication and data exchange between ship 112 and remote monitoring system control center 11o is established via communication link 120 and/or via satellite communication link 212. If the distance for cellular communication and data transfer is too great for direct communication between the ship 112 to the remote monitoring system control center 11o then an antenna relay 214 may be used located ashore, on an island or any other suitable base 240 for such a relay. Antenna relay 214 may act as a cell for one or more RAT.

Satellite communication link 212 may include a connection to one or more satellites in geosynchronous or geostationary orbit over the location of the ship 112. Equipment on the ship 112 (e.g., a satellite modem, etc.) may connect to network with a very-small-aperture terminal (VSAT), i.e., a two-way satellite ground station with a dish antenna that is smaller than 3.8 meters. The VSAT on the ship 112 may access satellites in geosynchronous orbit or geostationary orbit to relay data from the terminal on the ship 112 to other terminals (in e.g., mesh topology) or master Earth station “hubs” (in, e.g., a star topology). The ship 112 may be in continuous motion in all axes. The antenna on the ship 112 may be stabilized with respect to the horizon and true north as the ship 112 moves. Motors and sensors may be used to keep the antenna pointed accurately at the satellite. The motors and sensors enable the VSAT to transmit to and receive from a satellite over the satellite communication link 212 while minimizing losses and interference with adjacent satellites. In some examples, a solid-state device (flat panel) steers an antenna electronically without moving parts to accurately point at the satellite.

A navigational radar 216 (or radars) may also be used as part of the monitoring system. The navigational radar 216 (or radars) is located according to system navigational requirements to cover the navigational area of the ship's route and transfer the image to the marine pilot at remote monitoring system control center 110. Thus, data gathered off ship 112 may also be used and transferred to the remote monitoring system control center no.

The remote monitoring system may be equipped with cameras 210A-F and a navigational data module 218, with a transceiver device, to connect to one or more network and transmit real-time video to remote monitoring system control center no. The cameras 210A-F of remote monitoring system may be configured to capture the surroundings of the ship 112. The remote monitoring system collects navigational data and transmit all collected data to the remote monitoring system control center no located ashore 122. Additionally, communication devices (e.g., navigational data module 218) may be delivered in the package 118. Navigational data module 218 may be useful for information exchange between the ship's captain at sea 130 and the pilot located ashore 122 (or any other location of command center e.g., a ship designed to provide remote pilotage service). All network exchange may be operational in rainy, hailing, snowy, lightning, windy, low visibility, etc. weather conditions 132. This may be ensured via backup network connections (via terrestrial cellular networks and a satellite link) and relay stations to provide robust network operation in all weather conditions around the port (connectable by navigational data module 218).

In some examples, the remote monitoring system (e.g., cameras 210A-F and navigational data module 218) may be powered, in part, by internal batteries, external battery packs delivered on the package 118 of unmanned aircraft 116. In other examples, the remote monitoring system may connect to power sources on the ship 112. The modules may connect to the ship 112's power supply with cables delivered on the package 118 of unmanned aircraft 116.

One or more modules of remote monitoring system (e.g., cameras 210A-F) may include or have a built-in microphone to capture ambient audio (for transmission to the remote monitoring system control center 110). For example, in bad weather conditions 132, some ships may sound a tone indicating their presence. In such examples, the microphones of remote monitoring system may transmit this ambient audio to the remote pilot to assist in locating other vessels or other hazards.

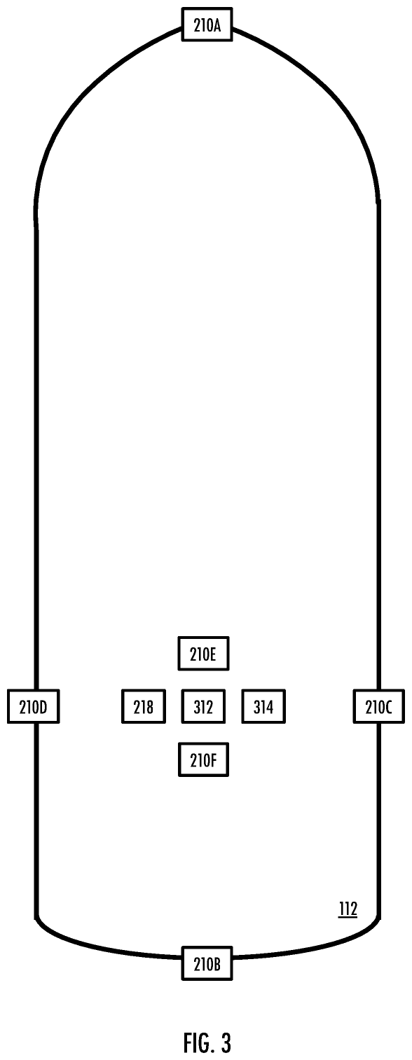

FIG. 3 is a block diagram illustrating an exemplary layout of remote monitoring system equipment on the ship 112. Referring to FIG. 3, all the equipment may be brought to the ship in the package 118 by unmanned aircraft 116. In other embodiments, multiple drones carrying multiple packages of equipment may be used. Cameras 210A-F of remote monitoring system are set-up on the sides of the ship (port and starboard) and in forward and aft section so that they provide coverage and capture video of the 360 degrees surrounding the ship 112 and transmit the captured video the remote monitoring system control center 110. In certain embodiments, less than 360-degree coverage is provided by the cameras 210A-F of remote monitoring system. For example, some blind spots may be acceptable in certain areas e.g., near the rear of the ship.

Marine pilots use a variety of information to assist in the navigation of a ship. This includes visual information, position information, heading information, rudder data, radar information, etc.

The location coordinates of the ship 112 may be determined using an onboard global positioning system (GPS) receiver. GPS is a type of Global Navigation Satellite System (GNSS) that use constellations of satellites based on trilateration where devices accurately determine their own location by measuring the distance to four or more satellites. The GPS receiver may receive information from a plurality of global positioning satellites in earth's orbit to calculate a position of ship 112. The GPS receiver aboard the ship 112 may plot the GPS determined coordinates on a display. The display may include a map and calculate and display information when taking into account other data (e.g., speed of the ship 112 and the planned course) such as how long a travel to a destination may take. Heading information may be determined using a gyroscope, e.g., gyro compass, and/or compass/satellite onboard the ship 112.

The rudder position may be determined using a rudder angle indicator (e.g., in degrees). The rudder angle indicator allows a navigation officer to control the rate of turn and rudder angle of the ship.

An echo sounder may be used to determine the depth of the water below the ship's bottom using sound waves.

Pilots may use radar data from, e.g., a parabolic rotating radar antenna located on the ship 112. The antenna may scan the X-band (10 GHz) or S-band (3 GHz) frequencies. The higher frequency X-band offers more bandwidth, and so can be used to provide sharper image/better resolution. The S-band may be less susceptible to rain/fog, and can be used for robust data delivery and/or critical data. The ship 112 may use the radar information for navigation as the ship 112/pilot can detect targets and display the information on a screen such as the distance of the ship from land, any floating objects (an island, rocks, iceberg etc.), other vessels, and obstacles to avoid a collision. A rotating antenna discovers the surrounding area of the ship 112. Radar information may be plotted on a display such as the automatic radar plotting aid (ARPA)). ARPA displays the position of the ship 112 and other vessels nearby. The radar displays the position of the ships in the vicinity and may aid in setting the course for the ship 112 by avoiding collisions.

The Electronic Chart Display System (ECDIS) is navigational equipment on the bridge of the ship 112 that interfaces with other navigation equipment, such as GPS, Gyro, RADAR and the echo sounder, etc. and displays an electronic nautical chart with the gathered data. The electronic nautical chart may include the number of targets, in this case ships, boats, stationary or floating objects etc., and plot their speeds and courses respectively. ECDIS may also present targets as vectors on a display screen and update the parameters with each turn of the antenna by calculating their nearest points of approach to the ship 112 and also presents the time before an approach (or collision) will occur.

The Automatic Identification System (AIS) is a navigation system which helps to identify and pinpoint the location and other navigational data of ships. AIS uses VHF radio channels as transmitters and receivers to send and receive messages between ships. The radio channels may include AIS 1 which operates on the 161.975 MHz frequency (channel 87B; simplex, for ship-to-ship transmissions) and AIS 2 which operates on the 162.025 MHz frequency (channel 88B; duplex for ship-to-shore transmissions). The AIS system typically includes one VHF transmitter, two VHF Time Division Multiple Access (TDMA) receivers (for using with self-organizing TDMA), one VHF digital selective calling (DSC) receiver for receiving distress alerts, and a standard marine electronic communications link to shipboard display and sensor systems. Position and timing information is normally derived from an integral or external GPS receiver. The International Maritime Organization (IMO) mandates all passenger vessels and commercial ships over 299 Gross Tonnage (GT) sailing in international waters to carry a Class A AIS transponder.

Data received and transmitted by the AIS include static information, dynamic information, voyage related information, and safety messages. Static information (transmitted every 6 minutes and on request) includes: Maritime Mobile Service Identity (MMSI) number, IMO number, name and call sign, length and beam, type of ship, and the location of position fixing antenna. Dynamic Information (the transmission rate depends on speed and course alteration) includes: the ship's position with accuracy indication, position timestamp (in UTC), and Course Over Ground (COG) information. Voyage Related Information (transmitted every 6 minutes, when data is amended, or on request) includes: the ship's draught, type of cargo, destination and estimated time of arrival (ETA), and the route plan (e.g., waypoints). The short safety-related messages include a free-format text message addressed to one or many destinations or to all stations in the area. This text message may include alerts such as a buoy missing, iceberg sighting, etc.

An Automatic Identification System (AIS) pilot plug (also known as an AIS plug or pilot plug), is a connector cable that enable pilots and other mariners to connect their own device (e.g., a laptop, tablet, phone) to the AIS port of ship 112. Some exemplary AIS plugs are wireless and may transmit AIS data via a communication link, e.g., Wi-Fi, Bluetooth, a cellular connection, etc. An application on the receiving device may receive and display/visualize the AIS data.

Radio/very high frequency (VHF) radio provides two-way communication and has a range of 5-30 miles. VHF radios split the spectrum into fifty-five channels (with U.S., Canadian and International menus). While a ship/pilot may listen to any of the fifty-five channels, most are reserved for government, commercial shipping, or Coast Guard use. A pilot may communicate with one or more traffic control station at the port to indicate the location of the ship via the radio/VHF. The port may respond with feedback about the ship and the ship's status. When onboard a ship, a pilot may use their own radio or an onboard radio of the ship's. In contrast, during remote pilotage, the pilot may be located at one of the traffic control stations at the port but may communicate with other traffic control stations via a personal VHF system or a VHF system at the remote monitoring system control center 110.

As a brief aside, traditionally, a pilot uses visuals/binoculars to determine/confirm that there are no obstacles e.g., other boats, in the intended path of the ship. Typically, the marine pilot will assist navigation from a conning position on the bridge/wheelhouse of the ship, where the main steering wheel, controls, engine room telegraph, etc., are located, with a commanding view (e.g., a view without obstructions which would interfere with the navigator's ability to perform all immediate tasks) and which is used by navigators when commanding, maneuvering, and controlling a ship's movements. Notably, regulations (by, e.g., the IMO implementing the SOLAS convention mandates visibility requirements from the navigation bridge of a ship. The SOLAS requirements include: (1) the view of the sea surface from the conning position cannot be obscured by more than 2 ship lengths or 500 m, whichever is less, forward of the bow to 10° on either side for all conditions of draft, trim and deck cargo under which the particular vessel is expected to operate; (2) from the main steering position, the horizontal field of vision is to extend over an are from right ahead to at least 60° on each side of the vessel; (3) the horizontal field of vision from the conning position is to extend over an arc of not less than 225°, that is, from right ahead to not less than 22.5° abaft the beam on either side of the vessel; (4) from each bridge wing, the horizontal field of vision is to extend over an are of at least 225°, that is, from at least 450 on the opposite bow to right ahead and from right ahead to right astern through 180° on the same side of the vessel; and (5) the vessel's side is to be visible from the bridge wing.

The apparatus and system described herein may provide substantially similar to the visibility requirements of SOLAS to provide for remote pilotage.

During remote pilotage, cameras may be set up around the ship 112 that provide a depiction of the visual field around the ship 112 that meets (or exceeds) the SOLAS convention mandates. Additionally, the placement of the cameras 210A-F (or the types of cameras/lenses on the cameras) of remote monitoring system may be based on characteristics of the ship 112, may be based on the port's topology/geography, the pilot preference (similar visuals to what the pilot is used to seeing), etc. Receiving one or more video feeds allows the remote pilot to obtain the visual information available from the bridge of the ship 112 remotely.

In one embodiment, a team of unmanned aircraft may fly and attach (or be attached) to different areas of the ship to provide the visual support. In some embodiments, the team of unmanned aircraft may be used to provide network support (i.e., act as mobile hotspots/cells).

Captured video from multiple cameras 210A-F may be received by a single coordinating device (e.g., navigational data module 218) of the remote monitoring system. The coordinating device may gather the disparate videos from certain cameras of the remote monitoring system and stitch the videos together as panoramic or spherical video before transferring the video to the remote monitoring system control center 110. For example, many fixed focal length cameras have a field-of-view of 60 degrees (though, wide angle cameras offer a larger field-of-view). The captured video from cameras 210A-F may be stitched together or otherwise combined (e.g., picture-in-picture, etc.) to provide a field-of-view substantially similar to the view (e.g., field of vision) from the bridge (or conning position) of the ship 112. In a specific example, captured video is stitched to meet or exceed one or more of the SOLAS visibility requirements described above. In other embodiments, the individual videos from cameras 210A-F are transferred to the remote monitoring system control center no where they are stitched together. In further embodiments, the videos are not stitched together and are displayed side by side (or in different windows). In an exemplary embodiment, the coordinating device may include the navigational data module 218.

Specifically, one or more cameras 210A, 210E, and 210F of the remote monitoring system may be installed on the front/bow of the ship 112 or on a deck by/above the bridge of the ship 112. The camera may be a front facing camera that is fixed in place (i.e., it does not move independently of the ship 112). In some examples, cameras 210E and/or 210F of remote monitoring system may be installed inside (or directly in front of) the bridge and/or a deck directly above the navigating bridge (“monkey island”), respectively. In some embodiments, the camera(s) 210A-F may zoom and pan, but the camera(s) once installed are connected to the ship 112 (rather than, e.g., an unmanned aircraft that flies above the ship 112 providing video coverage).

As a brief aside, experiments have been conducted using unmanned aircraft for use in pilotage. For example, VesCo Systems describes remote piloting in their presentation titled “Drones—An Aid to Increased Situational Awareness in Pilotage Operations.” VesCo Systems describes two systems for drone use: a first system including unmanned aircraft providing an aerial overview of the entrance and berth areas and a second system including a package delivery. In an example where such unmanned aircraft flies far from the ship 112 and cranes, the visuals provided by the unmanned aircraft camera may be inhibited. The angles provided by the unmanned aircraft cameras may be difficult for a marine pilot to judge distances between objects and to see, e.g., lines on a bollard at the port. If the pilot is unable to see the lines (due, e.g., to the ship blocking the camera), the pilot may be unable to safely instruct tugboats or the ship how to proceed to safely get the ship to berth. Using flying unmanned aircraft for visuals during remote pilotage may also add complexity to the system and may require separate drone pilots during pilotage. The view from the unmanned aircraft cameras in flight, however, may not meet the visibility requirements of a ship's bridge (required under SOLAS). Further, if used in combination with on-board cameras, the captured video cannot be easily stitched (to real-time streaming) due to the differing motion of the ship and the unmanned aircraft.

In some embodiments, a camera on an unmanned aircraft (e.g., the unmanned aircraft 116 that carries the package 118) may be used as the camera 210A/210E/210F of the remote monitoring system and installed/coupled to the bow/front of ship 112 by affixing the unmanned aircraft, for example, with an attachment mechanism, e.g., a tripod mount, hooks, clamps, etc. The fixed camera allows a pilot to see visuals in front of the ship (that would be more difficult or impossible only with footage from an unmanned aircraft alone). In some examples, one or more cameras are not in a fixed position (e.g., they may pivot or move on a track) but are physically coupled to the ship 112 (rather than, e.g., hovering over the ship 112). The cameras may also provide a visual that is closer to an angle the marine pilot is used to, e.g., a similar angle as one would view from inside the ship 112 rather than a bird's eye view perspective from an unmanned aircraft. This does not provide the visuals that the marine pilot needs as a marine pilot may be unable to judge the distances needed to effectively pilot ship 112. Determining distances from the video may be made even more difficult if the unmanned aircraft is moving relative to the ship 112.

Further, cameras 210C and 210D of remote monitoring system may be installed on the port and starboard sides of the ship 112 and camera 210B of the remote monitoring system on the stern of the ship 112. These cameras 210A-F either may be stand-alone cameras or cameras built onto an unmanned aircraft 116 (which is then installed/coupled to the ship 112). These cameras 210A-F improve upon unmanned aircraft that are disconnected from the ship 112 because even in examples where unmanned aircraft provide side coverage (of the area around the port and starboard sides of the ship 112), it is possible that the unmanned aircraft get hit/taken out by the ship 112 or by gantry cranes that load and unload cargo at the port and still cannot provide a conning position/bridge deck-like view.

A navigational data module navigational data module 218 may be set up on the bridge of the ship 112 to gather data generated or gathered by the ship 112 via a direct connection to the ship's integrated bridge (via, e.g., an AIS plug and other mechanisms to transfer ship data, including data described above, to a third-party device such as the navigational data module 218). The navigational data module 218 may transmit the data to the remote monitoring system control center 11o via communication link 120 (e.g., a (terrestrial) cellular network or a satellite communication via satellite communication link 212). Visibility data can be transmitted as a video stream from the cameras 210A-F of the remote monitoring system. The cameras 210A-F of the remote monitoring system may be set up to ensure the same or greater visibility (field of view) is afforded the marine pilot compared with the requirements of the IMO/SOLAS convention and implementing regulations. For example, cameras can be set up to have the resulting images/video have a greater than 225° field-of-view and/or a view of the sea at the bow/bridge of the ship 112.

A mobile device 312 (such as a tablet, a camera, etc.) may be used to exchange visual (video) information between the master/captain of the ship 112 and the marine pilot. A communication device 314 (e.g., a mobile phone, a microphone, etc.) may be used for communication between the captain of the ship 112 and the marine pilot. The mobile device 312 and/or the communication device 314 may be used by the captain of the ship 112 and/or the crew of the ship 112 throughout the pilotage operation. In another embodiment, the mobile device 312 may be part of the system of navigational data module 218.

### Exemplary Remote Pilotage Apparatus

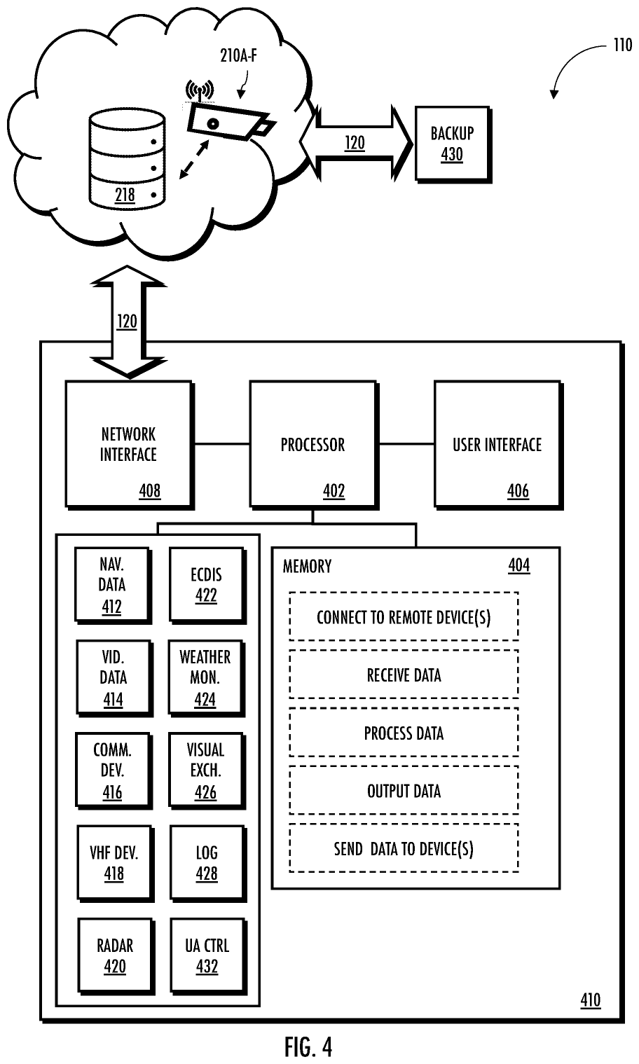

FIG. 4 is a logical block diagram illustrating the remote pilotage system 410 in the remote monitoring system control center 11o according to aspects of the present disclosure. The remote monitoring system control center 11o receives the data from the ship 112 at sea 130. A communication link 120 is established between the remote monitoring system control center 11o and the remote monitoring system located on the ship 112. Specifically, the navigational data module 218 on the ship 112 may connect to a remote pilotage system 410 (and backup remote pilotage system 430). The marine pilot may verify that each of the remote pilotage modules 412-428 are functioning properly. The marine pilot may verify that a communication link 120 is available and sufficiently robust (e.g., latency, bandwidth, throughput) for the remote pilotage operation. For example, status data may need to be updated at a certain threshold interval for it to be useful/usable by the pilot to effectively pilot the ship 112. Backup/redundant network connections as well as other redundant devices (standalone/independent devices, e.g., a standalone VHF radio) may be available to ensure stable remote pilotage in various conditions.

The remote pilotage system 410 includes a processor subsystem 402 (including a central processing unit (CPU) and/or a graphics processing unit (GPU)), a memory subsystem 404, a user interface subsystem 406, a network/data interface subsystem 408, and a bus to connect them. The remote pilotage system 410 may be connected and send data to/receive data from a monitoring and surveillance equipment on the ship 112 via a communication link 120 and present the data to the marine pilot to perform remote pilotage. During operation, the remote pilotage modules 412-428 of the remote pilotage system 410 receive data transmitted from the navigational data module 218 (and/or other modules) on the ship 112, and formats the data for presentation on display(s), via speakers, etc. In some embodiments, modules on the remote pilotage system 410 have analogous modules or systems or companion devices on the ship 112 (or on other vessels). For example, a VHF radio device 418 may be used to communicate with other companion devices, e.g., VHF radios, on the ship 112 (or other ships) or other parts of the port. In one exemplary embodiment, the remote pilotage system 410 may be a computer system that can receive, process, and present data from and about the conditions on and about ship 112. Still other embodiments of the remote pilotage system 410 include without limitation: a smart phone, a wearable computer device, a tablet, a laptop, a workstation, a server, and/or any other computing device.

In one embodiment, the processor subsystem may read instructions from the memory subsystem and execute them within one or more processors. The illustrated processor subsystem includes a GPU and CPU. GPU tasks may be parallelized and/or constrained by real-time budgets (e.g., real-time stitching of video data). Operations may be fixed-function operations or programmable (by e.g., applications operable on the CPU). In one specific implementation, the CPU controls device operation and/or performs tasks of arbitrary complexity/best-effort. CPU operations may include, without limitation: operating system (OS) functionality (power management, UX), memory management, etc. GPU operations may include performing graphical and video processing applications (e.g., stitching). Other processor subsystem implementations may multiply, combine, further subdivide, augment, and/or subsume the foregoing functionalities within these or other processing elements. For example, multiple GPUs may be used to perform high complexity operations in parallel.

In one embodiment, the user interface subsystem 406 may be used to present data to, and/or receive input from, a human user. In some embodiments, data may include audible, visual, and/or haptic data. Examples include images, videos, navigational displays, sounds, and/or vibration (e.g., based on a received alert). In some embodiments, input may be interpreted from touchscreen gestures, button presses, device motion, and/or commands (verbally spoken). The user interface subsystem 406 may include physical components (e.g., buttons, keyboards, switches, joysticks, scroll wheels, etc.) or virtualized components (via a touchscreen). In one exemplary embodiment, the user interface subsystem 406 may include an assortment of a touchscreen, physical buttons, a camera, a speaker, and a microphone.

In one embodiment, the network/data interface subsystem 408 may be used to receive data from, and/or transmit data to, other devices, e.g., the navigational data module 218 and/or the cameras 210A-F of the remote monitoring system located on the ship 112. For example, video data may be streamed (via, e.g., an MPEG transport stream), to the remote pilotage system 410 via the network/data interface subsystem 408. In some embodiments, data may be received/transmitted as transitory signals (e.g., electrical signaling over a transmission medium). In other embodiments, data may be received/transmitted as non-transitory symbols (e.g., bits read from non-transitory computer-readable media). The network/data interface subsystem may include: wired interfaces, and/or wireless interfaces. In one exemplary embodiment, the network/data interface subsystem 408 may include network interfaces including, but not limited to: Wi-Fi, Bluetooth, Global Positioning System (GPS), satellite (via e.g., satellite communication link 212), cellular (e.g., 3G, 4G LTE, 5G via e.g., communication link 120), USB, and/or Ethernet network interfaces.

The memory subsystem may be used to store (write) data locally at the remote pilotage system 410. In one exemplary embodiment, data may be stored as non-transitory symbols (e.g., bits read from non-transitory computer-readable mediums.) In one specific implementation, the memory subsystem 404 is physically realized as one or more physical memory chips (e.g., HDD or SDD and/or SRAM on the CPU) that are logically separated into memory data structures.

In one embodiment, the program code includes non-transitory instructions that when executed by the processor subsystem cause the processor subsystem to perform tasks which may include: calculations, and/or actuation of the sensor subsystem, user interface subsystem, and/or network/data interface subsystem.

The remote pilotage system 410 may be connected to one or more display. The display may be integrated into remote pilotage system 410 via the bus and GPU or may be connected to the remote pilotage system 410 via an external display connector (e.g., HDMI, USB-C, VGA, Thunderbolt, DVI, DisplayPort, etc.). The display may include any suitable configuration for displaying one or more frames rendered by the remote pilotage system 410. For example, the display may include a liquid crystal display (LCD), touchscreen LCD (e.g., capacitive display), light emitting diode (LED) display, projector, or other display device to present information to a user of the remote pilotage system 410 in a visual display.

The pilot monitors and controls operation from a conning position using the remote pilotage system 410. The remote pilot system 410 delivers a variety of information to the marine pilot to pilot the ship 112. The remote pilotage system 410 may receive data from the ship 112, process the data, and output the processed data for use by the pilot. The remote pilotage system 410 ingests, processes, and outputs data from various internal systems and modules for use by the pilot. These systems and modules include the ship's 112 navigational data module 218 which receives and processes navigational data 412 from the ship 112; camera 210A-F of the remote monitoring system transmits to the marine pilot live video streaming 414; a communication device 416 to receive and transmit audio and/or video communication with the command (e.g., the bridge crew) of the ship 112, a VHF radio device 418 for communication (e.g. with tugs and/or as a backup with ship 112); a radar image screen 420 to display radar images (with data from the navigational radar 216); ECDIS with navigational data 422; a weather conditions real time monitoring system 424 (to receive weather information from the ship 112 and/or from external weather sources); and a device (or an arrangement) for visual information exchange 426 with the captain of the ship 112 (to, e.g., a mobile device 312). Other information that may be received and presented by the remote pilotage system 410 includes characteristics of the ship including turning circle, stopping distance (at various speeds), and other maneuvering characteristics of the ship 112.

Additionally, the remote pilot system 410 includes recording and logging devices 428 to record received and sent data. Received data and video streams may be logged in logging devices 428. Logged data and video may be reviewed in response to an adverse event. While illustrated as modules of a single system (remote pilotage system 410), separate modules of the remote pilotage modules 412-428 may be on multiple separate systems. In some examples, these separate systems may be in communication and share data. In other examples, these separate systems do not communicate and act independently to provide data to the pilot. The remote monitoring system control center 11o includes a backup remote pilotage system 430 with all or substantially all the functionality of remote pilotage system 410.

Further, data used by the remote pilotage system 410 includes data received from devices on the ship 112 during pilotage, however the remote pilotage system 410 may gather data from other sources as well. For example, weather data may be gathered from private and governmental sources of information. VHF radio communication with other parts of the port, with other ships (e.g., tugboats assisting with the pilotage and third-party ships) may be used by the remote pilotage system 410. RADAR data may be gathered by sensors on ship 112 or on-site (e.g., on or near the remote monitoring system control center no such as from a port-based traffic control center) or off-site (e.g., navigational radar 216).

In some embodiments, the remote pilotage system 410 may also act as the drone control center. In one such case, the remote pilotage system 410 includes an unmanned aircraft control module 432. The marine pilot (or a separate unmanned aircraft pilot) may connect the remote pilotage system 410 with the unmanned aircraft 116 (via communication link 120) and control the operation of unmanned aircraft 116 to land on the ship 112 or from the ship 112 back to the drone control center. In other embodiments, unmanned aircraft control is performed by a separate (standalone) device or devices. Still other variants may be substituted with equal success by artisans of ordinary skill, given the contents of the present disclosure.

Pilotage may be used for both berthing and departure. On completion of the remote piloting operation, the remote monitoring system (including cameras 210A-F and navigational data module 218) are packed up and sent back via the unmanned aircraft 116. When ship 112 is departing the port, the remote pilotage operation is similar to the remote pilotage operation undertaken to pilot the ship 112 into port. The unmanned aircraft 116 may deliver the package 118 with the equipment of the remote monitoring system. The crew may set up the equipment of the remote monitoring system and a communication and data session may be established between the devices on the ship 112 and the remote pilotage system 410. Upon completion of the pilotage operation, the crew gathers the equipment of the remote monitoring system back into package 118 and loads the package 118 onto the unmanned aircraft 116. Once the unmanned aircraft 116 has departed from the ship 112, the unmanned aircraft 116 may takeoff and travel to the drone control center on the specialized vehicle 114 or the remote monitoring system control center 110 ashore 122 or at sea 130 on the specialized ship 134 depending on system configuration).

### Exemplary Unmanned Aircraft and Control Apparatuses

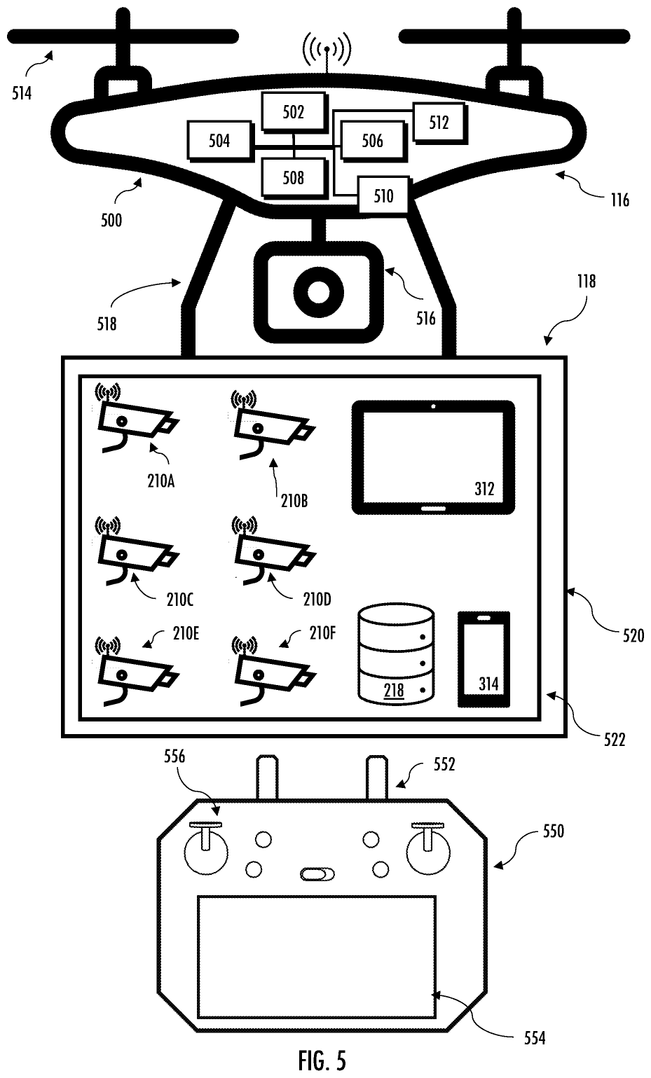

FIG. 5 is a logical block diagram illustrating an exemplary unmanned aircraft 116 with attached package 118 and unmanned aircraft controller apparatus 550 in accordance with aspects of the present disclosure. Unmanned aircraft 116 is configured to transport surveillance and monitoring equipment (in package 118) that enables remote pilotage of a vessel or ship. The surveillance and monitoring equipment may be stored on/at: specialized vehicle 114, remote monitoring system control center 110, specialized ship 134. Once the remote pilotage is complete, the unmanned aircraft 116 is configured to return the surveillance and monitoring equipment from the ship 112 to the storage facility.

The unmanned aircraft 116 may connected to devices on and transfer data and instructions with the ship 112, the unmanned aircraft controller apparatus 550, the drone control center, and/or the remote pilotage system 410 via a communication link 120 and/or satellite communication link 212. In one exemplary embodiment, the unmanned aircraft 116 may include any unmanned aircraft that can receive flight instructions and carry the weight of the package 118 to deliver (and retrieve) surveillance and monitoring equipment for remote pilotage to the ship 112.

The unmanned aircraft 116 includes a housing 500 that houses internal components including a processor subsystem 502 (including a central processing unit (CPU) and/or a graphics processing unit (GPU)), a memory subsystem 504, a user interface subsystem 506, a network/data interface subsystem 508, a battery 510, an engine 512 that spins rotors/propellers 514, and a camera 516, and a bus to connect the forgoing components. Housing 500 is also connected to a carrier component 518. Housing 500 may also include components to safely land the unmanned aircraft 116 and attach the unmanned aircraft 116 to various parts of the ship 112 (e.g., railings). As illustrated, unmanned aircraft 116 is shown as a multi-rotor/quadcopter-style body with four propellers 514. However, in other embodiments, unmanned aircraft 116 has a single rotor or a tri-, hex-, or octo-copter style body with one, three, six, eight (or more) rotors/propellers 514. In further embodiments, unmanned aircraft 116 includes a fixed wing body whose wings provide lift and gliding capability (versus the single or multi-rotor embodiments that achieve lift through the spinning rotors/propellers 514).

The battery 510 may be configured to provide power to all the various electronic and manual components of the unmanned aircraft 116. The battery 510 may be rechargeable, and housing 500 may include a port for recharging the battery 510.

The camera 516 may be configured to capture still images and video. The camera 516 may stream video to one or more other devices. The camera 516 may also transmit wirelessly images or video to aid in piloting the unmanned aircraft 116. The camera 516 (and thus the unmanned aircraft) may include a camera sensor, an image signal processor (ISP), a processing system, a codec, and removable storage media. In some embodiments, the unmanned aircraft 116 also includes one or more sensors including an accelerometer, a gyroscope, and/or other motion sensors.

In one embodiment, the processor subsystem may read instructions from the memory subsystem and execute them within one or more processors. The illustrated processor subsystem includes an image signal processor (ISP), a GPU and a CPU. In one specific implementation, the ISP performs graphics processing operations based on video frames captured by camera 516. The video may be transmitted to other devices, e.g., the unmanned aircraft controller apparatus 550, a drone control center, and/or the remote pilotage system 410 for display. The captured video may be used by the unmanned aircraft 116 to perform automatic (or semi-automatic) pilot operations. The GPU may be configured for efficient parallel processing. For example, video frames may be processed by a trained neural network in the processor subsystem to allow the unmanned aircraft 116 to autonomously or semi-autonomously fly to the ship 112. In other examples, the unmanned aircraft 116 may identify a landing site (e.g., designated area 124) on the ship 112 based on image processing and perform autonomous or semi-autonomous landing on ship 112. In other examples, the unmanned aircraft 116 may determine a proper location for one or more cameras of the monitoring and surveillance system based on image processing captured video data. The proper location may be based on visibility criteria (e.g., based on SOLAS regulations) regarding a pilot's view of the sea surface from a conning position on the ship 112.

GPU tasks may be parallelized and/or constrained by real-time budgets, e.g., image processing for autonomous operation and/or video streaming. Operations may be fixed-function operations or programmable (by e.g., applications operable on the CPU).

In one embodiment, the user interface subsystem 506 may be used to present navigation data and captured video/audio to, and/or receive input from, a human user (directly through, e.g., lights, displays, etc., and indirectly through other devices, e.g., the unmanned aircraft controller apparatus 550). In some embodiments, navigation data and captured video/audio may include audible, visual, and/or haptic content. In some embodiments, input may be interpreted from touchscreen gestures, button presses, device motion, and/or commands (verbally spoken) from a remote device, e.g., the unmanned aircraft controller apparatus 550, a drone control center, and/or the remote pilotage system 410 (or on the unmanned aircraft 116) via the communication link 120 or the satellite communication link 212.

In one embodiment, the network/data interface subsystem 508 may be used to receive data from, and/or transmit data to, other devices, e.g., the unmanned aircraft controller apparatus 550, a drone control center, and/or the remote pilotage system 410. In some embodiments, data may be received/transmitted as transitory signals (e.g., electrical signaling over a transmission medium). In other embodiments, data may be received/transmitted as non-transitory symbols (e.g., bits read from non-transitory computer-readable media). The network/data interface subsystem may include: wired interfaces, wireless interfaces, and/or removable memory media. In one exemplary embodiment, the network/data interface subsystem 508 may include network interfaces including, but not limited to: Wi-Fi, Bluetooth, Global Positioning System (GPS), satellite, cellular (3G, 4G LTE, 5G), USB, and/or Ethernet network interfaces. Additionally, the network/data interface subsystem 508 may include removable media interfaces such as: SD cards (and their derivatives) and/or any other optical/electrical/magnetic media (e.g., MMC cards, CDs, DVDs, tape, etc.).

The memory subsystem may be used to store (write) data locally at the unmanned aircraft 116. In one exemplary embodiment, data may be stored as non-transitory symbols (e.g., bits read from non-transitory computer-readable mediums.) In one specific implementation, the memory subsystem 504 is physically realized as one or more physical memory chips (e.g., NAND/NOR flash) that are logically separated into memory data structures. The memory subsystem may be bifurcated into program code and/or program data. In some variants, program code and/or program data may be further organized for dedicated and/or collaborative use. For example, the GPU and CPU may share a common memory buffer to facilitate large transfers of data therebetween. In other examples, GPU and CPU have separate or onboard memory. Onboard memory may provide more rapid and dedicated memory access. Additionally, memory subsystem 504 may include program data with a CPU Buffer and a GPU buffer. The memory subsystem 504 may include weighting information for neural network processing of video data captured by the unmanned aircraft 116.

In one embodiment, the program code includes non-transitory instructions that when executed by the processor subsystem cause the processor subsystem to perform tasks which may include: calculations, and/or actuation of a sensor subsystem, user interface subsystem, and/or network/data interface subsystem. In some embodiments, the program code may be statically stored within the unmanned aircraft 116 as firmware. In other embodiments, the program code may be dynamically stored (and changeable) via software updates. In some such variants, software may be subsequently updated by external parties and/or the user, based on various access permissions and procedures.

The unmanned aircraft 116 is configured to select, attach to, transport, and release the package 118 carrying monitoring and surveillance equipment for remote pilotage. The package 118 may include a container with a hard outer shell 520. The hard outer shell 520 is configured to withstand drops, bumps, and falls with and from the unmanned aircraft 116. In some embodiments, hard outer shell 520 is made of a hard plastic, e.g., polypropylene. Package 118 may include a hinged opening that has an internal gasket filled with an O-ring to seal package 118 and make package 118 waterproof. Latches may be used to lock the sides of the package 118 together when in the closed position. Depending on the weight of the contents of package 118, package 118 may be buoyant and float if dropped in the water for ease of retrieval.

Inside the hard outer shell 520 is a layer of foam padding 522. The foam padding may include polyurethane to protect the electronics and other contents inside the package 118. On the outside, the hard outer shell 520 may include one or more handles for ease of carrying once disconnected from the unmanned aircraft 116. In some examples, the hard outer shell 520 is formed (e.g., molded) with handles in place. The package 118 may also have a connector to attach to the unmanned aircraft 116. The connector may include passages for attachment devices such as rope or nylon/polypropylene webbing. Further examples may include a hoist mechanism (with e.g., a hook) on unmanned aircraft 116 that connects to the package 118.

In some examples, the unmanned aircraft 116 does not land on ship 112 and instead releases package 118 to lower/drop onto the ship 112. The unmanned aircraft 116 may pick up the package 118 at the completion of the remote pilotage without touching down on the ship 112 by hovering and lifting package 118 using, e.g., the hoist mechanism.

The package 118 may include monitoring and surveillance equipment to perform remote pilotage. In some examples, the package 118 is customized for certain types/classes of vessels and another package for other vessels. The unmanned aircraft 116 may select the package 118 (or be loaded with the package 118) that corresponds with the ship characteristics of the vessel requesting remote pilotage. In other examples, particular components (e.g., monitoring and surveillance equipment, networking equipment, attachment/stabilizing equipment, power/batteries, etc.) may be selected for each vessel after a request for pilotage is made. In further examples, a single generic package 118 that may provide the equipment (and backup) for most vessels is used by the unmanned aircraft 116.

Inside the package 118 may include camera equipment (such as the cameras of the modules of remote monitoring system 210A-F, as well as the navigational data module 218, mobile device 312, and communication device 314. Cables, e.g., power cords, power converters, AIS plug, etc. Package 118 may also include any other adapters/plugs/wires to facilitate data transfer from status information about the ship 112 to a network or for use by the pilot using the remote pilotage system 410 in the remote monitoring system control center no. Package 118 may also include padding (e.g., with foam) between the equipment inside package 118 to protect the equipment during transport.

In one example, the package includes cameras for placement around the vessel including a front-facing camera for placement on (or above) the bridge/at the bow of the vessel and on each of the two sides (starboard and port side). In some examples the cameras may be configured to rotate so they may be adjusted after placement, e.g., by the marine pilot on shore. The cameras may be equipped with wide angle lenses to cover a wide 180°+ view between the cameras. In some examples a 360° view can be achieved between multiple cameras.

In some embodiments, particularly for use in older ships without a digital hookup to the instrument panel or ship sensors, a camera may be installed on the bridge of the ship 112 and used to capture and stream one or more instrument panels on the bridge (or other areas of the ship 112). In a further embodiment, the video may be processed by, e.g., the camera, an intermediary device such as the navigational data module 218 (prior to streaming the data), or at the remote pilotage system 410 to extract the instrument data from the video stream. The processed data may then be streamed to the remote pilotage system 410 for display. In other embodiments, particularly for use in newer ships, instead or in addition to a bridge/instrument panel camera a digital hookup can be used (e.g., an AIS plug) to capture and stream instrument data to the remote pilotage system 410.

A device that may allow for “face to face” communication and document sharing between the captain/master of the ship 112 and the marine pilot may be included in the package 118, e.g., the mobile device 312 and/or the communication device 314. For example, a tablet computer or other device may provide for an information exchange to enable the pilot to remotely share the pilotage plans with the captain of the ship 112.

Network transmission equipment that may connect to the communication link 120 and/or the satellite communication link 212 to allow for efficient communication with the remote pilotage system 410 may be included in the package 118. The network transmission equipment may connect to one or more devices on the ship 112, monitoring and surveillance equipment in the package 118, etc. for ease and reliable networking. In some examples, the monitoring and surveillance equipment in the package 118 may be pre-setup with connections to the network transmission equipment so all devices in the package 118 are quickly setup and usable “out of the box.” Further, while wireless technology may allow devices to be placed anywhere, the package 118 may include cables for and the included devices may have hookups for wired networking. For example, a camera may have a wired connection to the network transmission equipment which may wirelessly connect to communication link 120.

Installation equipment and attachment mechanisms such as tripods, ball heads, clamps, tape, ties, and clips may be carried in package 118 for use with camera equipment. As each ship may be different, having a variety of installation equipment may ensure that cameras can be placed where needed to effectively to capture the required data (e.g., the front and sides of the ship, the rear of the ship, instrument panels, ship crew). As the availability and placement of power sources may vary with the ship, external battery packs to power equipment used for remote pilotage may be included in package 118. Extra/redundant/backup equipment may be included in the package 118 as well. While needing to balance overall weight of the package 118 as the package 118 is transported by the unmanned aircraft 116, to ensure safety and to reduce port delays, redundant devices may be included in package 118.

The unmanned aircraft controller apparatus 550 is configured to control the unmanned aircraft 116. The drone pilot may transmit instructions via the unmanned aircraft controller apparatus 550 which is configured to connect to the unmanned aircraft 116 via a communication link 120 (via antennas 552). The unmanned aircraft controller apparatus 550 may be configured to receive video captured by the unmanned aircraft 116 and display the video on display 554. The captured video may be real-time video captured to aid in piloting the unmanned aircraft 116. Controls 556 (including buttons, sliders, joysticks, etc.) may be used to indicate the instruction(s) to send to the unmanned aircraft 116.

### Methods

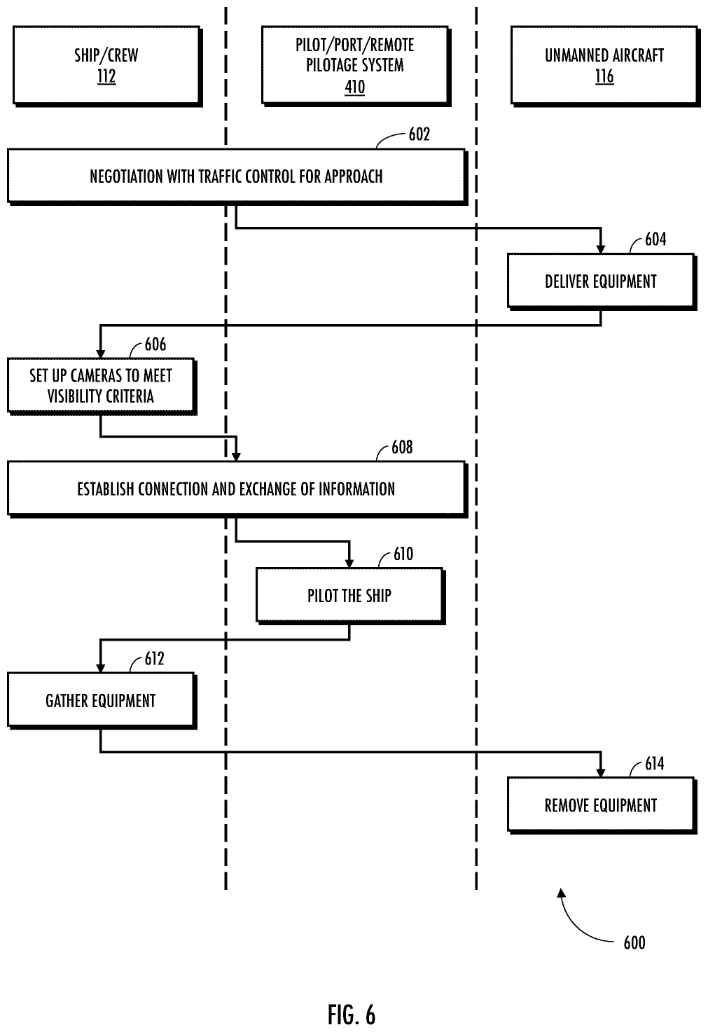

FIG. 6 is a logical flow diagram of one generalized method 600 for remote pilotage, in accordance with the various principles described herein.

In one example, the method 600 may include the (crew of) ship 112 negotiating with the port's traffic control center for an approach, at step 602. The ship 112 may be located outside of the port with its anchor down. In response to receiving instructions to proceed with the approach, the ship 112 may pick up its anchor. While described with respect to docking/berthing into a port, the same/similar steps may be taken for a ship 112 leaving port.

At step 604, equipment for remote monitoring system may be delivered to the ship. The unmanned aircraft 116 may deliver the package 118 to the ship 112 with monitoring and surveillance equipment to effectuate the remote pilotage. The monitoring and surveillance equipment may be standardized across all ships or may be selected based on the ship/type of ship.

At step 606, the monitoring and surveillance equipment delivered by the unmanned aircraft 116 may be unpacked and instructions associated with the equipment provided by the crew of the ship 112. The monitoring and surveillance equipment may be setup. For example, the cameras 210A-F may be setup on the ship 112 to meet visibility criteria. The visibility criteria may be based on IMO/SOLAS requirements.

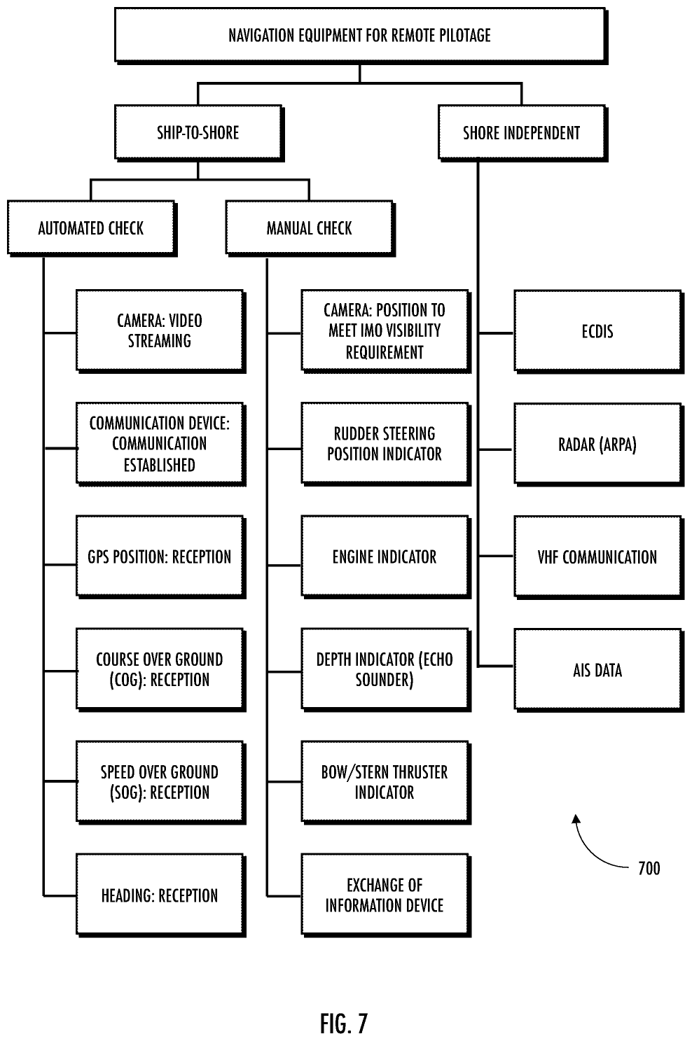

Assistance may be provided via VHF radio and/or an installation instruction manual with the equipment delivery. Referring also to FIG. 7, FIG. 7 is a block diagram 700 illustrating various navigational equipment useful for remote pilotage according to aspects of the present disclosure. Block diagram 700 illustrates the source of the pilotage data-whether the data is provided from ship 112 to the remote monitoring system control center 11o or whether the data is shore independent. For the ship-to-shore data, certain equipment/data may be checked automatically while other data may include manual checking.

On the ship 112, cameras 210A-F within package 118 may be setup by the ship's crew with a positioning that meets the IMO/SOLAS visibility requirements. Cameras 210A-F may be placed in various locations around the ship 112. For example, a camera may be placed on/above the bridge, at the bow/front, as well as at the port and starboard sides of the ship 112. In some examples, a camera is placed at the stern end of the ship 112 as well. In further examples, cameras may be placed to capture information on instrument panels in the bridge of the ship 112. Cameras/the video stream must be positioned correctly, with sufficient quality to see obstacles off the ship and instruments.

Instruments such as the rudder/steering position indicator, engine indicator, depth indicator (using e.g., the echo sounder), bow/stern thruster indicator, and an exchange of information device (e.g., navigational data module 218) may be setup, functionality checked (by e.g., an installer/crew member), and cameras 210A-F placed on them (if needed).

A navigational data module 218 may be installed (by an installer/crew member/the unmanned aircraft 116) to establish communication between the ship 112 and the pilot on shore (using, e.g., the remote pilotage system 410). Network and video/data streaming may be activated and established for the cameras 210A-F, a communication device, and a variety of data providers (such as the communication device) which may display or stream data such as a GPS device (GPS position data), Course Over Ground (COG) data, Speed Over Ground (SOG) data, and heading data. These devices and data providers may have an automated check to determine whether the devices have a proper network connection (e.g., reception, latency, bandwidth).

Other useful data may be collected from on- or off-ship sources. This data may include ECDIS data, RADAR data, VHF communication, and AIS data. For example, RADAR data may be provided to a remote pilot from the ship's onboard RADAR; alternatively, RADAR data may be received from an external radar antenna

Referring back to FIG. 6, at step 608, devices establish a network connection and information exchange between the ship 112 and the remote monitoring system control center 11o on shore 122. Various manual and electronic checks may be performed to ensure that all the needed data is available to the pilot at the remote monitoring system control center 110. For example, cameras may be checked to ensure that a video streaming session has been established as well as a check to test if the connection quality (e.g., bandwidth, latency is appropriate to sustain the connection and clearly present the needed data (e.g., instrument panels). Further, camera placement may be checked to ensure that the cameras provide at least the minimum visibility criteria to meet regulatory requirements as well as to ensure the pilot can use the video to pilot the ship.

The pilot may also exchange of information and the plan for docking/berthing with the crew of the ship 112.

At step 610, the pilot may remotely assist in navigating the ship 112 using the information received from the ship 112 and off the ship.

The pilot may transmit pilot instructions to various parties through various media in the remote pilotage system 410. For example, the pilot may give commands to the captain and those pilot commands may be transmitted to the crew of the ship 112. The pilot may also communicate pilot instructions with other vessels such as tugboats that may assist in moving the ship 112 to (or away from) port (if needed).

The pilot or a crew member may contact another (unrelated) ship that, e.g., may cross paths with the ship 112. The pilot may alert the other vessel by instructing the crew to blast the ship's horn.

At step 612, following completion of the remote piloting, the equipment unpacked and setup at step 606 may be repacked and placed in package 118.

At step 614, the equipment may be picked up and/or removed from the ship 112. In one example, the removal is by the unmanned aircraft 116. In another example, once at port the equipment is picked up directly.

### Technological Improvements and Other Considerations

The above-described system and method solves a technological problem in industry practice related to the safety of piloting shipping vessels. The various solutions described herein directly address a problem that is created by simulating an in-person piloting experience remotely, so a pilot does not have to potentially risk their life to safely board and pilot a ship to port. Specifically, technological tools such as unmanned aircraft, as well as communications and monitoring equipment (cameras, communications and network equipment, ship/equipment status information) provide a technological solution to a real-world problem. Various aspects of the present disclosure resolve the safety issue identified by providing mechanisms for remote pilotage. Improvements are made to various technologies on the ship and on shore to create a safe and robust environment for remote pilotage.

As a related consideration, existing techniques for the use of unmanned aircraft to aid remote pilotage create additional safety concerns. A hovering drone may attempt to move with the ship and creates effectiveness issues and well as posing its own safety issues (e.g., crashing/risk of crashing into port equipment) and feasibility problems (e.g. the inability of a marine pilot to judge distances from shaky video). As a result, in many cases, these techniques are unsuitable for remote pilotage operation. The various solutions described herein enable remote pilotage of vessels through improvements to unmanned vehicle technology, networking topologies, etc. In other words, the techniques described herein represent an improvement to various interrelated fields of technology.

### Additional Configuration Considerations

Throughout this specification, some embodiments have used the expressions “comprises,” “comprising,” “includes,” “including,” “has,” “having” or any other variation thereof, all of which are intended to cover a non-exclusive inclusion. For example, a process, method, article, or apparatus that comprises a list of elements is not necessarily limited to only those elements but may include other elements not expressly listed or inherent to such process, method, article, or apparatus.

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Aspects of the disclosure are disclosed in this description. Alternate embodiments of the present disclosure and their equivalents may be devised without departing from the spirit or scope of the present disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

As used herein, the term “computer program” or “software” is meant to include any sequence of human or machine cognizable steps which perform a function. Such program may be rendered in virtually any programming language or environment including, for example, Python, JavaScript, Java, C#/C++, C, Go/Golang, R, Swift, PHP, Dart, Kotlin, MATLAB, Perl, Ruby, Rust, Scala, and the like.

As used herein, the terms “integrated circuit”, is meant to refer to an electronic circuit manufactured by the patterned diffusion of trace elements into the surface of a thin substrate of semiconductor material. By way of non-limiting example, integrated circuits may include field programmable gate arrays (e.g., FPGAs), a programmable logic device (PLD), reconfigurable computer fabrics (RCFs), systems on a chip (SoC), application-specific integrated circuits (ASICs), and/or other types of integrated circuits.

As used herein, the term “memory” includes any type of integrated circuit or other storage device adapted for storing digital data including, without limitation, ROM. PROM, EEPROM, DRAM, Mobile DRAM, SDRAM, DDR/2 SDRAM, EDO/FPMS, RLDRAM, SRAM, “flash” memory (e.g., NAND/NOR), memristor memory, and PSRAM.

As used herein, the term “processing unit” is meant generally to include digital processing devices. By way of non-limiting example, digital processing devices may include one or more of digital signal processors (DSPs), reduced instruction set computers (RISC), general-purpose (CISC) processors, microprocessors, gate arrays (e.g., field programmable gate arrays (FPGAs)), PLDs, reconfigurable computer fabrics (RCFs), array processors, secure microprocessors, application-specific integrated circuits (ASICs), and/or other digital processing devices. Such digital processors may be contained on a single unitary IC die or distributed across multiple components.

Upon reading this disclosure, those of skill in the art will appreciate still additional alternative structural and functional designs as disclosed from the principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

It will be recognized that while certain aspects of the technology are described in terms of a specific sequence of steps of a method, these descriptions are only illustrative of the broader methods of the disclosure and may be modified as required by the particular application. Certain steps may be rendered unnecessary or optional under certain circumstances. Additionally, certain steps or functionality may be added to the disclosed implementations, or the order of performance of two or more steps permuted. All such variations are considered to be encompassed within the disclosure disclosed and claimed herein.

While the above detailed description has shown, described, and pointed out novel features of the disclosure as applied to various implementations, it will be understood that various omissions, substitutions, and changes in the form and details of the device or process illustrated may be made by those skilled in the art without departing from the disclosure. The foregoing description is of the best mode presently contemplated of carrying out the principles of the disclosure. This description is in no way meant to be limiting, but rather should be taken as illustrative of the general principles of the technology. The scope of the disclosure should be determined with reference to the claims.

It will be appreciated that the various ones of the foregoing aspects of the present disclosure, or any parts or functions thereof, may be implemented using hardware, software, firmware, tangible, and non-transitory computer-readable or computer usable storage media having instructions stored thereon, or a combination thereof, and may be implemented in one or more computer systems.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. A system for remote piloting a vessel comprising:
a case comprising a camera and an attachment mechanism, where the camera is connectable to a network, and the attachment mechanism is configured to attach the camera to a bridge of the vessel;
an unmanned aircraft configured to transport the case to the vessel; and
a remote pilotage system comprising:
a network interface;
a display;
a processor; and
a non-transitory computer-readable medium comprising instructions which, when executed by the processor, causes the remote pilotage system to:
connect to the network via the network interface;
receive video from the camera on the bridge of the vessel; and
display the video on the display.

2. The system of claim 1, where the remote pilotage system further comprises a communication device configured to communicate with a companion device on the vessel.

3. The system of claim 2, where the communication device is configured to connect to the network.

4. The system of claim 2, where the communication device enables transmission of pilot instructions to the vessel based on the video received from the camera.

5. The system of claim 1, where the network comprises a cellular network.

6. The system of claim 1, where network the camera is connectable to comprises a satellite communication link.

7. The system of claim 1, where the case further comprises an Automatic Identification System (AIS) pilot plug configured to:
interface with an AIS port on the vessel; and
transmit AIS data retrieved from the AIS port over the network.

8. The system of claim 7, where the instructions, when executed by the processor, further causes the remote pilotage system to:
receive the AIS data via the network interface; and
display the AIS data on the display.

9. The system of claim 1, where the instructions, when executed by the processor, further causes the remote pilotage system to:
receive status data about the vessel from one or more devices on the vessel; and
perform a test that the status data is updated at a threshold interval.

10. The system of claim 9, where the status data include at least one of a position information, a course over ground (COG) data, a speed over ground (SOG) data, and a heading information.

11. The system of claim 9, wherein the case further comprises a transceiver device configured to:
receive the status data from the vessel; and
transmit the status data to the remote pilotage system via the network.

12. A method for establishing remote pilotage of a ship, comprising:
delivering one or more cameras to the ship by an unmanned aircraft;
capturing images via the one or more cameras, at least one of the one or more cameras installed on a bridge of the ship; and
causing the one or more cameras to transmit the images to a remote pilotage system.

13. The method of claim 12, further comprising:
receiving, by a transceiver device from the one or more cameras, the images; and
transmitting, by the transceiver device, the images to the remote pilotage system.

14. The method of claim 12, further comprising: displaying a stream of video based on the images, the stream of video having a horizontal field-of-view of at least 225° from a bridge of the ship.

15. The method of claim 12, where the one or more cameras comprises at least two cameras, and the method further comprises stitching the images from the at least two cameras to create panoramic images having a field-of-view of at least 225°.

16. The method of claim 12, further comprising retrieving the one or more cameras from the ship by the unmanned aircraft after the remote pilotage of the ship.

17. An unmanned aircraft apparatus configured to assist remote piloting a vessel comprising:
a network interface;
a camera;
an attachment mechanism, configured to attach to a bridge of the vessel;
a processor; and
a non-transitory computer-readable medium comprising instructions which, when executed by the processor, causes the unmanned aircraft apparatus to:
connect to a network via the network interface;
receive commands to fly to the vessel via the network; and
fly to the vessel in response to the commands.

18. The unmanned aircraft apparatus of claim 17, where the unmanned aircraft apparatus is configured to couple to the bridge of the vessel via the attachment mechanism.

19. The unmanned aircraft apparatus of claim 17, where the instructions, when executed by the processor, further causes the unmanned aircraft apparatus to:
capture video with the camera from the bridge of the vessel; and
transmit the video to a remote pilotage system via the network.

20. The unmanned aircraft apparatus of claim 17, where the instructions which, when executed by the processor, further causes the unmanned aircraft apparatus to land at a designated area of the vessel.
